(19) United States
(12) Patent Application Publication
(10) Pub. No.: US 2007/0063120 A1
(43) Pub. Date: Mar. 22, 2007

(54) Ladder tool and equipment hook

(76) Inventor: George Miller Robbins, Austin, TX (US)

Correspondence Address: George Miller Robbins, 11612 Parkfield Dr., Austin, TX, 78758-3740, US

(21) Appl. No.: 11/440,735

(22) Filed: May 25, 2006

Related U.S. Application Data
(60) Provisional application No. 60/685,967, filed on May 31, 2005.

(51) Int. Cl. F16B 45/00

(52) U.S. Cl. 248/304

(57) ABSTRACT

Ladder Tool & Equipment Hook is a hook made of a single piece of steel or steel alloy which can be hung on the rung of a ladder to hold tools, equipment, pails, or tool pouches weighing up to 20 pounds. This hook is designed to allow a workman to hang a saw, nail gun, or paint gun on the hook by use of the handle grip. It is further designed to allow the ladder it is hanging on to be moved gently without unloading the hook.

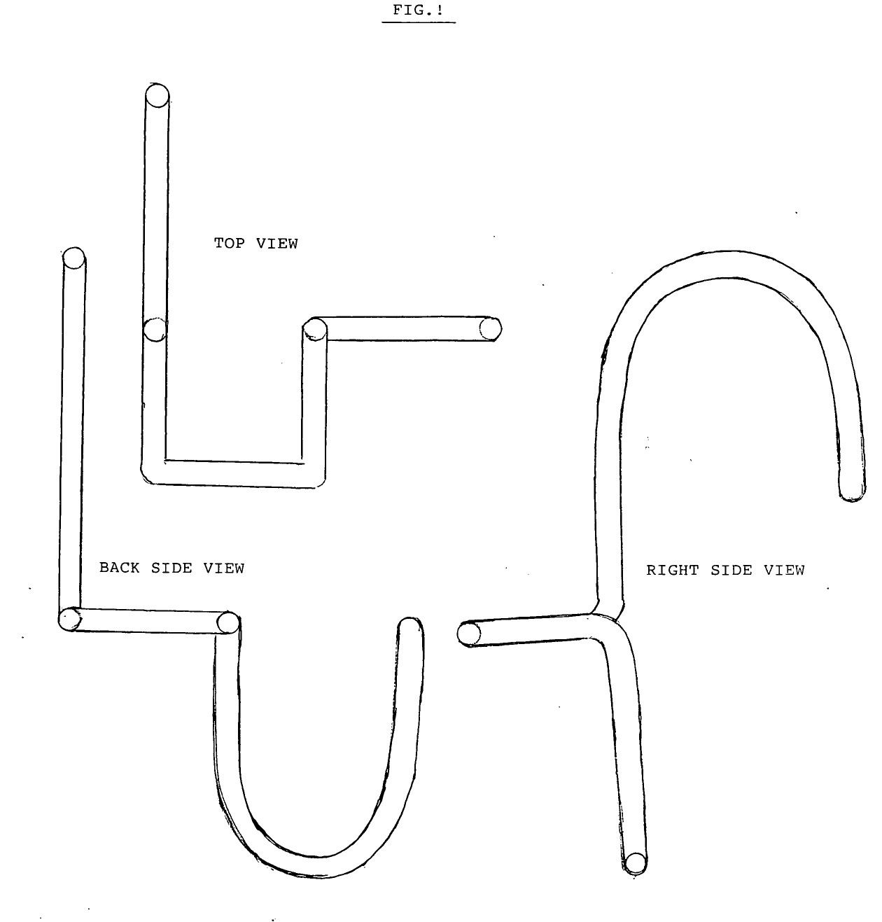

Page 1 or 3: FIG. 1 is mechanical drawings of a right side hook to be made of steel rod With a minimum of ⅛ inch width, which will provide enough strength to hold a nail Gun, saw equipment, or any equipment or container of similar weight.

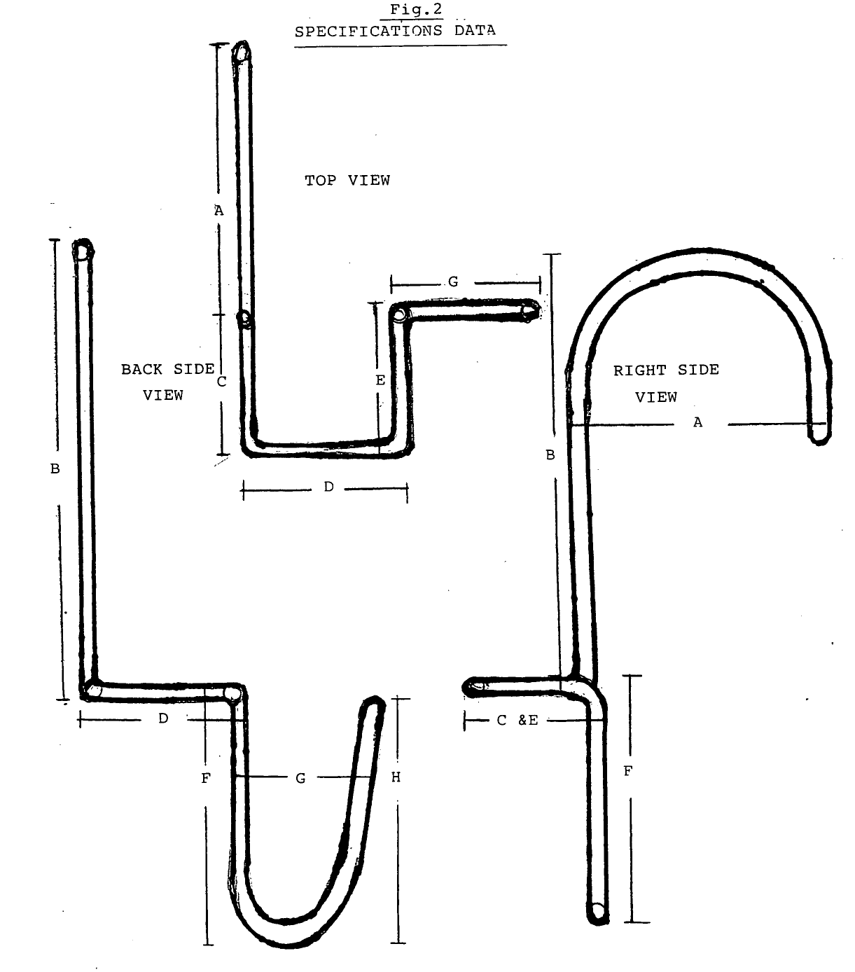

Page 2 of 3: FIG. 2 is mechanical drawings of a right side hook marked for specification data.

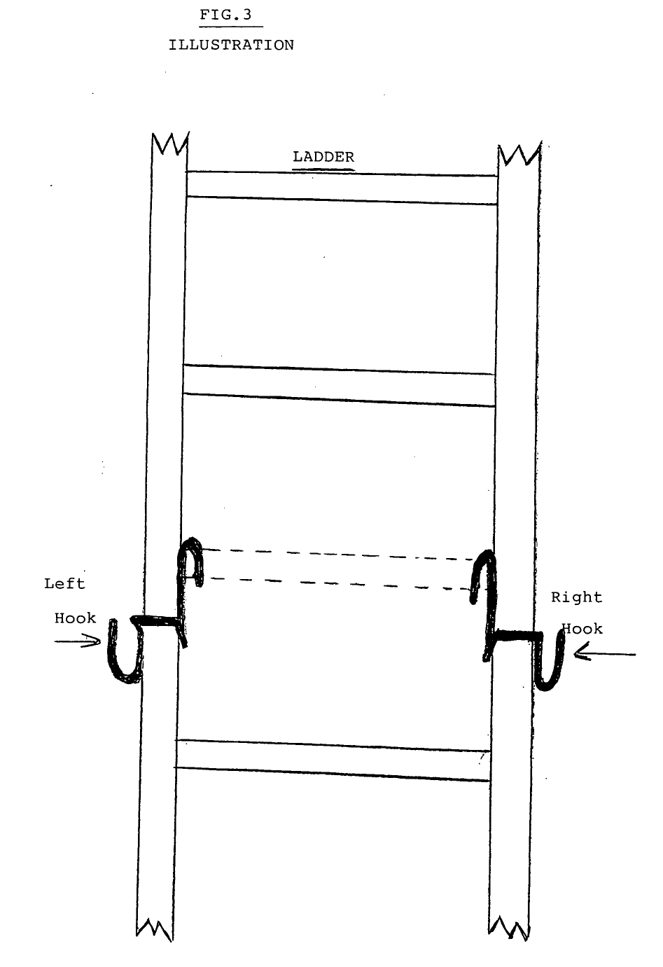

Page 3 of 3: FIG. 3 is an illustration of how the hook, one on the right and one on the left are to be used on a ladder.

These specifications are written for maximum strength, durability, and stability of this hook. These specifications contain no new data.

Drawings page 2 of 3:

Reference A. measures 2¼ inches to form a hook to fit over a ladder rung.

Reference B. measures 3⅝ inches; the vertical part from the rung hook to the offset notch that fits around the ladder side rail. This is a proper length to allow the hook to hang plumb when the ladder is set at the proper angle.

Reference C, D, and E measures 1⅝ inch each, which forms a notch that fits around a ladder side rail to hold the hook and it's equipment or contents stable and will not allow the hook and contents to sway.

Reference F, G, and H forms the lower hook measuring 1⅝ inches wide and 2¼ inches deep to hold the equipment or container while the person is working on the ladder.

This hook can easily be made of steel or steel alloy rod with bending tools and a jig made for the purpose of maintaining the proper shape or by use of manufacturing equipment programmed to make the bends as specified. This hook can also be made by the use of molds to mold the steel or steel alloy into the proper specifications. A hook for the right side or left side of a ladder can be made in the same manner by reversing the angle of the notch that fits around the ladder side-rail.

This hook can be used on a ladder in a stationery position or it can easily be moved from one ladder rung of a ladder to another with one hand while holding on to the ladder with the other hand without having to unload the hook to move it from one rung of the ladder to another.

LADDER TOOL & EQUIPMENT HOOK is more stable on a ladder than any similar hook previously patented.

U.S. Patent Documents for Similar Use:
U.S. Pat. No. 6,585,204 B1
U.S. Pat. No. 6,431,509 B1
U.S. Pat. No. 6,250,595 B1
U.S. Pat. No. 5,845,742
U.S. Pat. No. 5,797,571
U.S. Pat. No. 5,687,941
U.S. Pat. No. 5,305,977
U.S. Pat. No. 5,154,383
U.S. Pat. No. 5,062,607
U.S. Pat. No. 3,979,097

Similar Devises on Sale in Market Places:
Werner: “Extension Ladder Can Hook” SKU 6316715
Werner: “Paint Can Hook” 1998 P/N 80729-01
Hyde Tools: “Swivel Twist Lock Pail Hook” SKU 45110
Warner: “Swivel Pot Hook” SKU 34411
AWP: “Clip Strip Monster Tool Hook” SKU 142352
None of the above listed devises match LADDER TOOL & EQUIPMENT HOOK. A patent search has been done, and no patent was found with the same specifications as specified in this patent application.

1. This hook is my own invention and has never been made by another person or company. I have made similar hooks for my own personal use, using the same basic design as this hook, by taking the bail off a used paint can and bending the bail to form a very similar shaped hook for the purpose of hanging paint pails on a ladder while painting from a ladder and while cleaning windows from a ladder.
This invention holds a paint pail bail next to the ladder so the material in the pail can easily be accessed. It also works the same way for a carpenter with nails, screws, and etc. in a container that can be hung on a hook of these specifications. Window washers and people of other trades can find this hook very useful for many purposes other than what has been mentioned in this application.
I have made a hook to these specifications and tested it for strength, durability, and usability.
